(19) United States
(12) Patent Application Publication
(10) Pub. No.: US 2004/0167726 A1
(43) Pub. Date: Aug. 26, 2004

(54) Method of flow control

(76) Inventor: Gino James Rouss, Bartlett, TN (US)

Correspondence Address: Charles F. Rye, Attorney at Law, 707 Adams Avenue, Memphis, TN, 38105, US

(21) Appl. No.: 10/374,128

(22) Filed: Feb. 25, 2003

(51) Int. Cl. G06G 7/48

(52) U.S. Cl. 702/50

(57) ABSTRACT

An improved method of flow control by developing a dimensionless model describing Reynolds number values of a pipe as a function of Reynolds numbers of a flow control device connected to the pipe. The model describes the effect on flow performance of the flow control device due to variations of choke sizes operatively installed in proximity to the flow control device. The model is then utilized to determine the characteristic dimension of a choke to be placed in proximity to a flow control device in order to achieve a desired flow coefficient value.

### BACKGROUND

Obtaining the desired flow control is critical in the operation of fluid systems. Current design practice is limited by the inherent flow characteristics of available manufactured flow control devices. Examples of flow characteristics which must be considered when selecting a flow control device are the flow coefficient, the rangeability factor, and the turndown ratio. Designers are thus constrained in the design of fluid systems to a limited set of flow control devices, which often results in inefficient system operation.

In order to modify the flow characteristics of a flow control device, chokes, or orifice plates, may be installed near the device. It is a known practice to install chokes in combination with valves to alter their flow characteristics. However, a designer considering using a choke in a fluid system is restricted both by a limited set of manufactured chokes and a complex series of testing and calculation that must be performed to design a choke to meet a specific system requirement.

Further, some valve designs have attempted to address the issue of inherent flow characteristic limitations by incorporating a set of interchangeable orifices with the valve, as disclosed by Mirandi, U.S. Pat. No. 5,937,890 (issued Aug. 7, 1999) and Fisher, U.S. Pat. No. 3,386,461 (issued Jun. 4, 1968). Although these designs afford some degree of flexibility in the design of fluid systems, a designer is nonetheless restricted to fixed set of flow coefficient values provided by the manufacturer. Furthermore, the interchangeable orifices are designed solely for use with the particular manufacturer's valve, which in turn limits the options for valves to be used in a specific application.

Additionally, designers often are forced to implement a particular type of valve due to its desirable performance in one aspect and are simultaneously forced to modify the design in order to accommodate for the undesirable features in another aspect. In particular, globe valves offer designers flow control properties superior to ball valves, but require greater physical space and accessibility for operation. For example, operation of a ball valve from its fully open position, and hence maximum flow rate, typically results in a dramatic decrease in flow rate as the control element of the ball valve is rotated past the initial range of operation toward the closed position. This range of erratic behavior thus limits the applications of a particular model of ball valve. A globe valve, by contrast, offers a much greater degree of flow control in the same range of operation. However, by modifying the maximum flow rate of a ball valve by installing a choke proximate to the ball valve, the ball valve can be adapted to provide flow control throughout a range that would have previously been within this area of erratic behavior. Thus, if the flow characteristics of the ball valve could be modified to a desired flow characteristic, the modified ball valve could be used in place of the globe valve, yielding a more efficient design.

Current fluid system designs are also constrained by dimensional sizing methods, such as the widely used standard of flow coefficient (C_{ν}). The disadvantage of a dimensional sizing method is that the calculations are limited to a particular size of valve and piping system. A dimensionless method of sizing, such as one based on Reynolds numbers, would be more appropriate from an engineering standpoint.

For the foregoing reasons, there is a need for a method to quickly and accurately design a choke to modify the flow rate of a flow control device, or a valve, to obtain a desired flow coefficient value.

### SUMMARY

In one aspect the method of the present invention the flow coefficient values for a plurality of experimental chokes are determined. From the measured values of flow coefficient (C_{ν}), the corresponding volumetric flow rate (Q) values are determined. Using the calculated C_{ν} values, two sets of Reynolds numbers are determined. One set of Reynolds numbers will be calculated from the inner diameter of the pipe in which the experimental choke is installed. The second set of Reynolds numbers is calculated from the inner, or throat, diameter of each of the experimental chokes. Using a regression analysis, a dimensionless model is determined to express the Reynolds number of the experimental chokes as a function of the Reynolds number of the pipe. From this model, the diameter of a choke corresponding to a desired value of flow coefficient is determined.

In another aspect the method of the present invention models the flow performance of flow control devices with various orifice diameters in terms of Reynolds numbers. The use of Reynolds numbers is a significant departure from accepted choke sizing practice, in that a Reynolds-based model is dimensionless. A dimensionless model allows for the results of experimental testing on a particular set of flow restrictions to be utilized in determining the characteristic dimension of a choke to be used in combination with a flow restriction whose nominal size was not tested. Current methods require either extensive testing or performing a lengthy set of calculations for each size of flow restriction.

In still another aspect, the present invention includes a method for determining the orifice diameter for a specified C_{ν}, wherein a model comprised of performance characteristics of a set of flow restrictions is used to determine the characteristic dimension of a choke corresponding to a specified flow coefficient.

### BRIEF DESCRIPTION OF THE DRAWINGS

These and other features, aspects, and advantages of the present invention will become better understood with reference to the following description and appended claims

FIG. 1 is a graph showing the plot of valve Reynolds numbers and pipe Reynolds numbers for the 1¼″ ball valve.

FIG. 2 is a graph showing the plot of valve Reynolds numbers and pipe Reynolds numbers for the 1½″ ball valve.

FIG. 3 is a graph showing the plot of valve Reynolds numbers and pipe Reynolds numbers for the 2″ ball valve.

FIG. 4 is a combined graph showing the valve Reynolds numbers and pipe Reynolds numbers for the 1¼″, 1½″, and 2″ ball valves with a trend line describing the set of data points.

### DESCRIPTION

The following terms are used to describe the present invention and their respective meanings are as follows:

“Choke” refers to a type of flow control device. The choke is typically sized by its internal, or throat diameter, which is referred to as the characteristic dimension of the device. The choke operates by restricting fluid flow through its inner diameter. The outside diameter of the choke is dictated by the inner diameter of the point of installation. The choke may be installed proximately upstream of the existing flow control device to modify the flow characteristics of the existing device.

“Flow control device” refers to a device installed in a flow system which restricts the fluid flow. The flow control device may be, but is not limited to, any of a variety of commercially available valves.

“Pipe test section” refers to a length of piping of a specified diameter.

“Reynolds-based model” refers to a mathematical model expressing the Reynolds number for the flow of a fluid through a flow control device as a function of the Reynolds number for the flow of a fluid through the pipe connected to the flow restriction device.

“Valve test section” refers to an existing flow restriction connected to two substantially equivalent lengths of pipe. The valve test section is configured either without a choke installed or with one of a plurality of chokes installed proximately upstream of the valve.

### Overview

The concept of the present invention relies upon the modeling of the flow characteristics of a flow restriction by Reynolds number values for various values of the characteristic dimension of the flow restriction. For incompressible fluid flow in piping systems, the Reynolds number (Re) is a function of a fluid properties density ρ, absolute viscosity μ as well as average velocity V of the flow and the characteristic dimension of the duct cross-section D of the flow restriction, and may be expressed as follows:

$$Re = \frac{ρ V d}{μ {g}_{c}}$$

Those skilled in the art will appreciate the significance of a Reynolds-based model in that the Reynolds number is a dimensionless value, allowing for the development of a model that incorporates flow measurements from multiple pipe line sizes. Further, such a dimensionless model is able to predict flow performance for pipe line sizes not evaluated in the development of the model.

A method for flow control having features of the present invention comprises the elements of modeling the flow performance of a modified flow control device in terms of Reynolds numbers, and using a Reynolds based model to determine the characteristic dimension of a choke to yield a desired value of flow coefficient. The method of modeling the flow performance of modified flow control device is comprised of the steps of determining the flow coefficient values for a flow control device alone and in combination with a plurality of experimental chokes; determining Reynolds number values for the open pipe corresponding to each measured flow coefficient value; determining Reynolds number values for the valve for each measured flow coefficient value; determining a model expressing the Reynolds number values for the valve as a function of the Reynolds number for the pipe; and then determining the characteristic dimension of a choke corresponding to a desired flow coefficient value from the Reynolds expression.

The accuracy of such a model is essentially limited by the minimum and maximum flow coefficient measured. For instance, if a minimum C_{ν} of 5 is measured in a ½″ valve test and a maximum C_{ν} of 50 is measured in a 1″ valve test, the model will predict choke dimensions for any desired C_{ν} within 5 to 50 with acceptable error rates. The accuracy of predictions is a significant improvement over current methods in use by the valve industry, where errors in excess of 10% are routinely accepted.

Although a Reynolds-based model theoretically can predict C_{ν} values outside of the range tested with acceptable accuracy, it is recommended that such calculations be compared to a known standard. For instance, if a Reynolds-based model was developed over a range of tested C_{ν} values for ¾″ and 1″ valves from 5-50, and a prediction for a C_{ν} of 70 were desired for a 1½″ valve, the accuracy of the prediction could be verified by comparing the experimental result calculated for the inner diameter of a known 1½″ valve corresponding to the manufacturer's rated C_{ν} value for the valve against the actual measurement of the inner diameter for the known valve. If the error exceeded acceptable limits, developing a model of the 1½″ valve may be required.

The method of designing a choke to modify a flow control device is comprised of generating a Reynolds-based model describing the flow performance of a plurality of chokes, selecting a value for the inner diameter of a pipe connected to a flow control device; selecting a value for the desired flow coefficient through the flow control device; determining a value for the Reynolds number of the pipe; using the values for the Reynolds number of the pipe and the desired flow coefficient in the Reynolds-based model to calculate the characteristic dimension of a choke corresponding to the desired flow coefficient value; and machining a choke to the determined characteristic dimension. The individual elements of the above describe methods are presented in greater detail below.

### 1. Modeling Flow Performance

Returning to the method of modeling flow performance, the first step involves determining the flow coefficient values for a plurality of experimental chokes is further comprised of additional steps. Initially, a set of experimental chokes is prepared. The experimental chokes are machined with varying inner diameters, with the purpose being to demonstrate the effect of varying the inner diameter on the flow performance of a flow restriction. The precise number of experimental chokes prepared is not critical, but generally the more experimental chokes prepared and evaluated will result in greater accuracy of the model developed.

Although the method may be performed without installing the experimental chokes in proximity to a flow control device, it is typically desirable to evaluate the flow performance of a flow control device in combination with a plurality of chokes. In this manner, the effect of varying the effective characteristic dimension on a particular flow control device may be observed. Accordingly, the present method discusses such an evaluation, while realizing that one skilled in the art would understand that the method is not limited to including existing flow control devices in the analysis.

For each flow control device tested, the flow performance of the device is evaluated alone and with each of the plurality of the chokes installed. The exact design of the experimental chokes employed is not critical. For instance, the choke may be constructed of a sufficiently rigid material in a disc configuration wherein the inner diameter is machined to a specified value. Further the choke may be operatively installed by physically connecting it to the upstream intake of the valve, or the choke may be installed between a pipe flange installed proximately upstream of the valve. However, the particular choke design employed should not allow for fluid leakage around the outer perimeter of the choke and should be constructed of material of sufficient rigidity to withstand the pressures involved in the flow testing without deflecting or its shape being otherwise altered.

It should be noted that various methods of experimentally determining flow coefficient are known in the industry for determining the flow coefficient of a flow control device, such as a valve or choke, as a function of the geometry of the flow control device. While different relationships may be used in the practice of the present invention, the test procedures employed herein are present as being exemplary for use in the method of the present invention, and thus the flow coefficients may be determined in accordance with the following procedure: Measuring flow performance; determining the differential pressure loss of the pipe; determining the differential pressure loss for the valve test; determining an expression for the differential pressure loss across the valve by subtracting the differential pressure loss due to the pipe; and using the expression to determine the value of flow coefficient.

A. Measurement of Flow Performance

In this procedure, measurements of the differential pressure (Δp) and volumetric flow rate (Q) are recorded. These measurements are obtained in accordance with methods which are standard to the valve industry. In particular, the standards set forth in ISA S75.02, which is hereby specifically incorporated by reference, are followed to determine the placement of sensors to obtain the differential pressure and volumetric flow rate data. The experimental apparatus employed to evaluate the pipe test sections and the plurality of valve test sections is essentially comprised of a centrifugal pump which discharges a test fluid from a sump tank into a piping circuit. The flow rate of the piping circuit is controlled by a control valve that is manually adjusted to obtain a desired flow rate. The piping circuit returns the test fluid into the sump tank, where it is continually pumped into to piping circuit. The piping circuit further allows for a section to be replaced, wherein a pipe test section or one of the plurality of valve test sections may be installed in the piping circuit and the flow performance of the particular test section is evaluated.

B. Differential Pressure in Pipe Test Section

In the step of measuring the flow rate of the pipe test section, a length of pipe of a specified diameter is installed in the piping circuit and measurements for differential pressure (Δp) are taken as the volumetric flow rate is varied. The flow rate is increased until the maximum flow rate is observed. Once the measurement data is obtained, differential pressure (Δpₚᵢₚₑ) is plotted as a function of the volumetric flow rate (Q).

C. Differential Pressure Loss in Valve Test Section

In the step of measuring the flow rate of the valve test section, a valve is installed between two substantially equivalent lengths of pipe, in which the nominal diameter of the lengths of pipe are equivalent to the nominal diameter of the pipe test section. The valve may be, but is not required to be, of a nominal diameter equivalent to the nominal diameter of the pipe test section. With the valve installed, the valve test section is installed into the piping circuit and measurements for differential pressure (Δp) are taken as the volumetric flow rate is varied. Once the data is obtained, differential pressure (Δpₚᵢₚₑ₊ᵥₐₗᵥₑ) is plotted as a function of the volumetric flow rate (Q).

For each choked valve test section, the following procedure is performed:

1. Install orifice proximately upstream of valve;

2. Adjust flow rate to desired setting and record Q and pressure;

3. Slightly increase flow rate, wait for steady state and record Q and pressure; and

4. Repeat until max flow rate observed.

Performing a linear regression, the equation describing a best-fit line passing through the data points is expressed as a 2^{nd} order polynomial.

D. Calculating Flow Coefficient

In order to calculate flow coefficient (C₈₄ ) it is necessary to isolate the differential pressure loss due to the valve from the differential pressure loss occasioned by the pipe. The data measured from the pipe test can be plotted with the differential pressure loss described as a function of volumetric flow rate. The equation of best fit line can be described as a 2^{nd} order polynomial of the following form:

Δpₚᵢₚₑ=M1*Q²+M2*Q+M3

where: M1, M2, and M3 are coefficients for curve fit.

Likewise, the differential pressure loss due to the pipe and test valve can be expressed as a function of volumetric flow rate, wherein the equation of a best fit line takes the form:

Δpₚᵢₚₑ₊ᵥₐₗᵥₑ=N1*Q²+N2*Q+N3

where: N1, N2, and N3 are coefficients for curve fit.

With the above equations, the effects of the differential pressure due to the pipe can be subtracted. An equation describing the relationship is:

Δpᵥₐₗᵥₑ=Δpₚᵢₚₑ₊ᵥₐₗᵥₑ−Δpᵥₐₗᵥₑ

=K1*Q²+K2*Q+K3

where: K1, K2, and K3 are coefficients for curve fit.

As discussed above the flow coefficient (C_{ν}) is defined as the number of gallons per minute of water that will flow through the test valve at a 1-psi differential pressure drop across the valve. Thus, by substituting the value of 1-psi for Δp_{ν}, Q will be given by the positive solution to the quadratic equation.

Given this value for Q, the corresponding value for the flow coefficient (C_{ν}) can be calculated by substituting the value for Q into the following equation:

$${C}_{v} = \frac{Q}{\sqrt{\frac{Δ {p}_{v}}{{G}_{g}}}}$$

where: Q=Volumetric flow rate (gpm);

Δp_{ν}=differential pressure across the valve (psi); and

G_{g}=specific gravity of fluid relative to water (unitless).

C_{ν} is commonly used in practice to describe the performance of a flow control device wherein water is the system fluid. However, the above relationship may also be used to determine the flow coefficient, or, as the relationship is sometimes referred to in non-water applications, the discharge coefficient, when a fluid other than water is used in the flow system by simply determining G_{g} for the particular fluid.

### Procedure for Determining Experimental Choke Sizes

The process of selecting the values for the inner diameters of the experimental chokes is simplified by the following method, wherein an initial set of experimental chokes, which could be 4 different inner diameters, are evaluated and the results are used to predict the inner diameter values of subsequent experimental chokes. Once the initial experimental chokes specimens have been tested and the resultant flow coefficient values (C_{ν}) calculated, the orifice diameter (d₀) corresponding to a desired value for C_{ν} can be determined. By assuming a linear relationship exists between the measured diameter of the inserts and the resulting flow coefficient (C_{ν}) values, linear interpolation is used to predict the new orifice diameter for the next experimental insert that will yield the desired flow coefficient (C_{ν}) value. By plotting orifice C_{ν} values as a function of orifice diameter, the slope of a line between 2 data points can be expressed as follows:

$$m = \frac{{C}_{v0} - {C}_{v1}}{{d}_{0} - {d}_{1}}$$

where: C_{ν0}=initial value of C_{ν};

C_{ν1}=value of C_{ν} at second point of interest;

d₀=initial value of choke diameter (in); and

d₁=value of choke diameter at second point of interest (in).

After a value for the slope between two data points is determined, a linear relationship can be used to predict the inner diameter of an orifice which will result in a desired value of flow coefficient. The mathematical relationship is specified by the following expression:

$${d}^{′} = {d}_{0} - ( \frac{{C}_{v0} - {C}_{vg}}{m} )$$

where: d′=resultant choke diameter (in);

d₀=initial value of choke diameter (in);

C_{ν0}=initial value of C_{ν};

C_{νg}=given value of C_{ν}; and

m=the slope of a line between two data points.

After determining the resultant orifice diameter corresponding to the given flow coefficient value, a new orifice is prepared with the specified inner diameter and tested. Next, the flow performance of the new orifice insert is evaluated and the flow coefficient is calculated. If this flow coefficient (C_{ν}) value is not the same as the given value, the new value is then used as a point of interest when using linear interpolation to determine the next experimental orifice diameter. This procedure is performed repeatedly until testing proves that the measured orifice diameter yields the appropriate flow coefficient value.

### Dimensional Analysis

The next step in the method involves the calculation of Reynolds number values using the values of C_{ν} determined from the first step. The derivation of the Reynolds number equations employed in the present invention are presented below. The Reynolds number is a ratio of inertia forces to viscous forces in the flow. For incompressible fluid flow in piping systems, the Reynolds number is a function of a fluid properties density ρ, absolute viscosity μ as well as average velocity V of the flow and the characteristic dimension of the duct cross-section D of the flow restriction.

$$Re = \frac{ρ V D}{μ {g}_{c}}$$

where: V=Average velocity of flow (ft/s);

D=Characteristic dimension, or diameter, of the duct cross section (ft);

ρ=Density of fluid (Ibm/ft³);

μ=Absolute viscosity of fluid

$$( \frac{lbf \cdot s}{{ft}^{2}} ) ;$$

and

g_{c}=Conversion factor

$$( 32.2 lbm \cdot ft / lbf \cdot {s}^{2} )$$

The Reynolds number can be simplified by substituting the kinematic viscosity term, ν, as follows:

$$Re = \frac{V D}{v}$$

where: V=Average velocity of fluid flow (ft/s);

D=Characteristic dimension of the duct cross section (ft); and

ν=Kinematic viscosity of fluid (ft²/s).

When determining the Reynolds number of a flow control device with a substantially circular characteristic dimension of the duct cross section, the internal diameter of the flow control device may be substituted for the characteristic dimension. Thus, the Reynolds number can be calculated for the flow through a choke by substituting the inner, or throat, diameter (d₀) of the choke for the characteristic dimension, D, of the duct cross section. This resulting expression is given by:

$${Re}_{do} = \frac{V {d}_{o}}{v}$$

where: V=Average velocity of flow (ft/s);

d₀=Diameter of orifice insert (ft); and

ν=Kinematic viscosity of fluid (ft²/s).

The average velocity of a fluid through a piping system is related to the volumetric flow rate of the fluid and the cross-sectional area of the system in the following manner:

$$V = \frac{Q}{A}$$

where: Q=Volumetric flow rate (ft/s); and

A=Cross-sectional area of pipe (ft²).

However, when calculating the average velocity of a fluid through an orifice, the cross sectional area of the above relationship is defined as the area of the orifice in the following manner:

$${A}_{do} = \frac{π {d}_{o}^{2}}{4}$$

where: d₀=Inner diameter of the orifice insert (ft).

By substituting the equation for A_{d0},the average velocity of a fluid through an orifice can be expressed as:

$${V}_{do} = \frac{4 Q}{π {d}_{o}^{2}}$$

where: Q=Volumetric flow rate (ft/s); and

d₀=Inner diameter of orifice (ft).

Next, the above equation for V_{d0} can be substituted into the simplified Reynolds equation, and the following expression for the Reynolds number of a fluid flowing through an orifice results:

$${Re}_{do} = \frac{4 Q}{π {d}_{o} v}$$

where: Q=Volumetric flow rate (ft³/s);

d₀=Inner diameter of orifice insert (ft); and

ν=Kinematic viscosity of fluid (ft²/s).

The above relationship defines data on the vertical axis in the dimensional analysis.

In a manner similar to the above derivation, a relationship describing the Reynolds number for the flow of a fluid through the pipe test section (Re_{di}) can be determined in a similar manner to the derivation above. In this instance, the actual inner diameter of the pipe connected to the choke (dᵢ) is substituted for the characteristic dimension of the duct cross section. The resulting expression is given by:

$${Re}_{di} = \frac{4 Q}{π {d}_{i} v}$$

where:

dᵢ=Actual inside diameter of pipe (ft).

The above relationship defines data on the horizontal axis in the dimensional analysis.

### Determination of Reynolds-based Model

After each set of Reynolds number for the pipe test sections and the corresponding Reynolds numbers for the valve test section and orifice modifications are collected, the data can be plotted in order to determine if a common trend in the data is observable. This may be performed on a computer using a spreadsheet program. Plotting the value for the Reynolds number of the pipe section on the x-axis and the values for the Reynolds number of the valve test section on the y-axis gives shows a clear trend in the data. With the data plotted, a linear regression is performed. The linear regression shows that a 3^{rd} order polynomial can be used to represent the data. The equation is of the following form:

Re_{d0}=Z1*Re_{di}³+Z2*Re_{di}²+Z3*Re_{di}+Z4

where: Z1, Z2, Z3 and Z4 are coefficients for curve fit.

Given the above relationship, an equation describing the inner diameter of an orifice required to yield a specified C_{ν} value can be expressed in the following form:

$${d}_{o} = \frac{4 Q}{π {Re}_{do} v}$$

where: Q=Volumetric flow rate (ft³/s); and

ν=Kinematic viscosity of fluid (ft²/s).

### EXAMPLE

By way of illustration, the flow performance for three valve test sections is performed to demonstrate the dimensionless Reynolds trend and the accuracy of the model developed in accordance with the method of the present invention. Three ball valves, 1¼″, 1½″, and 2″ are installed between two lengths of schedule 80 PVC pipe. The size of the pipe in each valve test section corresponds to the nominal size of each valve. Three pipe test sections similarly are comprised of 1¼″, 1½″, and 2″ schedule 80 PVC pipe.

For each valve test section, the flow performance is measured for the valve alone and with each of a plurality of experimental chokes installed proximately upstream of the valve. An initial set of experimental chokes are prepared and evaluated. Next the data obtained is analyzed according to the linear interpolation procedure described above to prepare additional experimental chokes to evaluate flow performance at other points of interest.

The procedures employed and results of each of the three valve test sections are each discussed in turn:

1. 1¼″ Ball Valve

For the 1¼″ ball valve, the flow performance with eight experimental orifices was evaluated. The test sections were constructed and the differential pressure drop through the 1¼″ pipe was recorded and graphed. The flow coefficient was determined for the 1¼″ ball valve without an insert installed, then a range of initial experimental chokes sizes were tested in order to use linear interpolation to approximate the new orifice diameters for the inserts that would yield further points of interest. New inserts were then machined and evaluated.

2. 1½″ Ball Valve

For the 1½″ ball valve, the flow performance with eight experimental orifices was evaluated. The test sections were constructed and the differential pressure drop through the 1½″ pipe was recorded and graphed. The flow coefficient was determined for the 1½″ ball valve without an insert installed, then a range of initial experimental choke sizes were tested in order to use linear interpolation to approximate the new orifice diameters for the inserts that would yield the further points of interest. New inserts were then machined and evaluated.

3. 2″ Valve Test

For the 2″ ball valve, the flow performance with sixteen experimental orifices was evaluated. The test sections were constructed and the differential pressure drop through the 2″ pipe was recorded and graphed. The flow coefficient was determined for the 2″ ball valve without an insert installed, then a range of initial experimental choke sizes were tested in order to use linear interpolation to approximate the new orifice diameters for the inserts that would yield the new orifice diameters for the inserts that would yield the further points of interest. New inserts were then machined and evaluated.

After obtaining all of the experimental data for the inserts, the results were tabulated and a graph was developed using dimensional analysis. As discussed above, the data are represented by Reynolds numbers. The Reynolds number for the flow through each orifice Re_{d0} is calculated is given by the following expression:

$${Re}_{do} = \frac{4 Q}{π {d}_{o} v}$$

where: Q=Volumetric flow rate (ft³/s);

d₀=Orifice diameter (ft); and

ν=Kinematic viscosity of fluid (ft²/s).

The Reynolds number for the flow through each pipe (Re_{di}) is given by the following expression:

$${Re}_{di} = \frac{4 Q}{π {d}_{i} v}$$

where: Q=volumetric flow rate (ft³/s);

dᵢ=actual inside diameter of pipe (ft); and

ν=kinematic viscosity of fluid (ft²/s)

The calculated values for Re_{d0} and Re_{di} corresponding to the inner diameter of the choke (d₀), flow coefficient (C_{ν}), and volumetric flow rate (Q) as determined above are presented for the 1¼″, 1½″, and 2″ valve tests in TABLES 1, 2, and 3 below:

TABLE 1
1.25″

| dₒ (in) | Cᵥ | Q (ft³/s) | Re_{di} | Re_{do} |
|---|---|---|---|---|
| 0.500 | 7.10 | 0.0158 | 20183 | 51589 |
| 0.595 | 9.65 | 0.0215 | 27432 | 58922 |
| 0.606 | 10.01 | 0.0223 | 28456 | 60011 |
| 0.625 | 11.10 | 0.0247 | 31554 | 64523 |
| 0.750 | 20.10 | 0.0448 | 57139 | 97365 |
| 0.830 | 28.64 | 0.0638 | 81416 | 125361 |
| 0.889 | 39.50 | 0.0880 | 112288 | 161423 |
| 0.942 | 49.30 | 0.1098 | 140147 | 190136 |
| 1.184 | 82.50 | 0.1838 | 234527 | 253253 |

TABLE 2
1.5″

| dₒ (in) | Cᵥ | Q (ft³/s) | Re_{di} | Re_{do} |
|---|---|---|---|---|
| 0.750 | 18.1 | 0.0403 | 43839 | 87677 |
| 0.782 | 18.68 | 0.0416 | 45243 | 86784 |
| 0.817 | 20.05 | 0.0447 | 48561 | 89158 |
| 0.873 | 22.45 | 0.0500 | 54374 | 93427 |
| 0.928 | 28.90 | 0.0644 | 69996 | 113141 |
| 0.931 | 29.30 | 0.0653 | 70965 | 114337 |
| 0.952 | 32.60 | 0.0726 | 78958 | 124408 |
| 1.023 | 38.70 | 0.0862 | 93732 | 137504 |
| 1.060 | 46.10 | 0.1027 | 111655 | 158003 |
| 1.071 | 49.11 | 0.1094 | 118945 | 166590 |
| 1.074 | 49.80 | 0.1110 | 120617 | 168459 |
| 1.496 | 143.50 | 0.3197 | 347560 | 348466 |

TABLE 3
2.0″

| dₒ (in) | Cᵥ | Q (ft³/s) | Re_{di} | Re_{do} |
|---|---|---|---|---|
| 1.000 | 26.68 | 0.0594 | 49984 | 96929 |
| 1.055 | 28.78 | 0.0641 | 53918 | 99108 |
| 1.062 | 29.72 | 0.0662 | 55679 | 101670 |
| 1.220 | 41.40 | 0.0922 | 77562 | 123285 |
| 1.250 | 42.66 | 0.0950 | 79922 | 123988 |
| 1.280 | 44.87 | 0.1000 | 84063 | 127355 |
| 1.278 | 46.90 | 0.1045 | 87866 | 133325 |
| 1.295 | 48.05 | 0.1071 | 90020 | 134801 |
| 1.310 | 50.36 | 0.1122 | 94348 | 139664 |
| 1.375 | 61.50 | 0.1370 | 115218 | 162495 |
| 1.420 | 67.20 | 0.1497 | 125897 | 171929 |
| 1.460 | 77.80 | 0.1733 | 145756 | 193596 |
| 1.467 | 78.29 | 0.1744 | 146674 | 193885 |
| 1.468 | 79.96 | 0.1782 | 149803 | 197913 |
| 1.469 | 85.46 | 0.1904 | 160107 | 211354 |
| 1.480 | 86.77 | 0.1933 | 162561 | 212999 |
| 1.974 | 271.00 | 0.6038 | 507710 | 498759 |

It is noted that the largest d₀ value in each table represents the flow performance of the valve in the fully open position without an experimental choke installed.

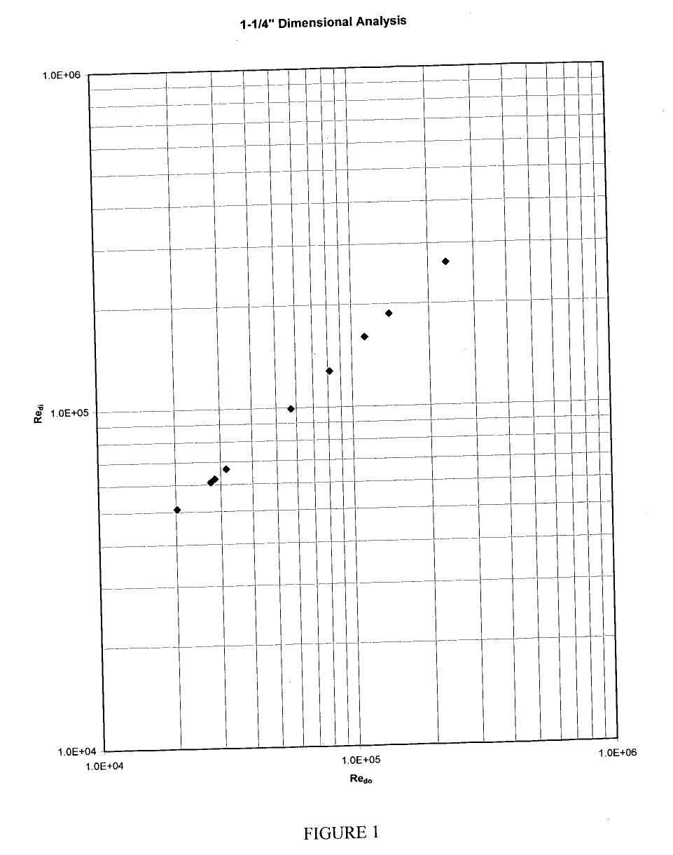

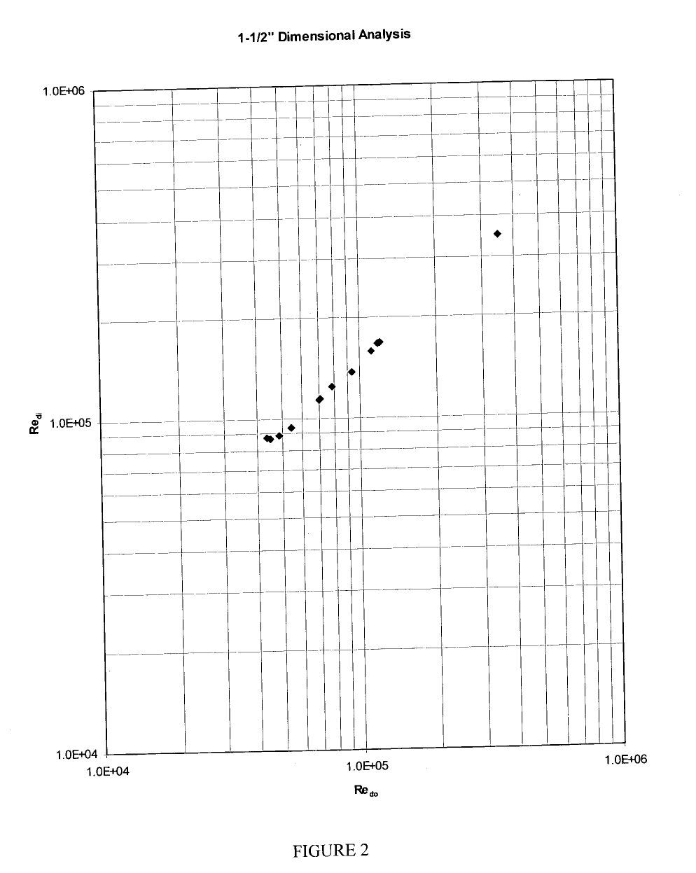

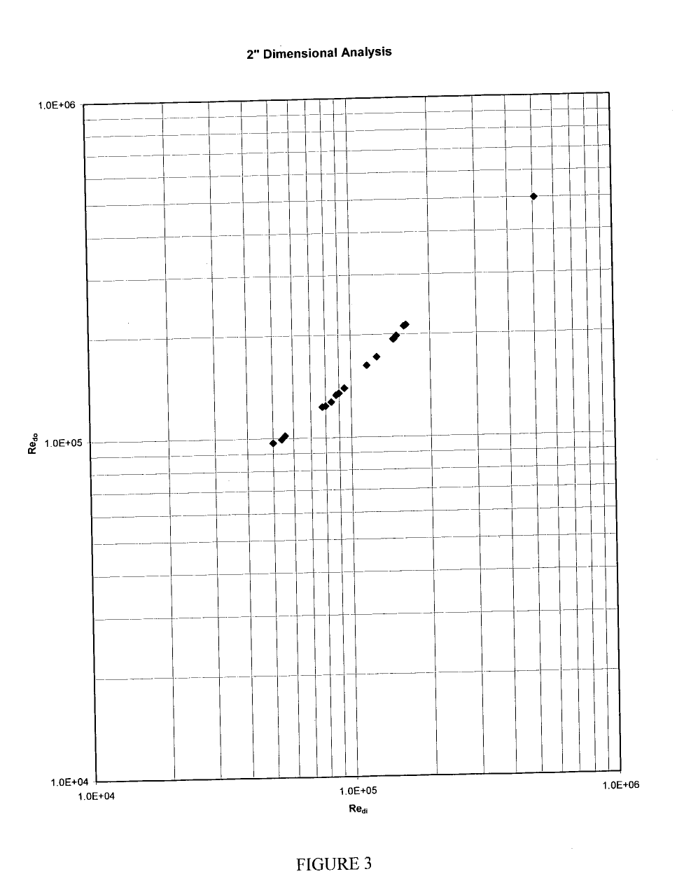

Once the calculations are made, a dimensionless graph was created. The object was to generate a common trend between all of the data points. FIGS. 1, 2, and 3 show graphs of the values for the Reynolds number for the flow through each orifice Re_{d0} versus the values for the Reynolds number for the flow through each pipe Redi for the 1¼″, 1½″, and 2″ valves, respectively.

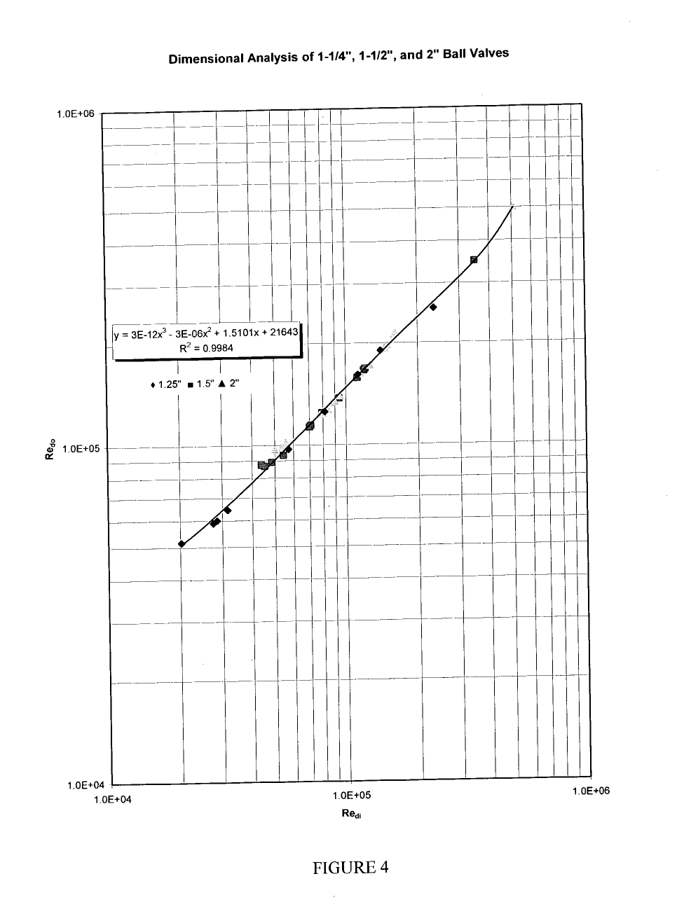

With the Reynolds data plotted, a clear trend in the data was apparent. From the Reynolds data, it was then possible to perform a curve fitting to describe a line passing through the data points. FIG. 4 shows the data points for all three valve tests plotted together with a best-fit line. The best-fit line was a 3^{rd} order polynomial describing the Reynolds number for the flow though each orifice as a function of the Reynolds number for the flow through each pipe. The equation of this best-fit line is expressed as:

Re_{d0}3×10⁻¹²Re_{di}³−3×10⁻⁶Re_{di}²+1.5101Re_{di}+21643

Additionally, the coefficient of determination, R², was calculated to be 0.9984.

In order to demonstrate the accuracy of choke characteristic dimension determinations, the above described method was used to calculate theoretical values for the choke Reynolds number (Re_{d0TH}) for each experimental choke diameter (d₀) value used in developing the model. Values for the theoretical choke diameter, d_{0TH}, were calculated from the theoretical Reynolds number values. The theoretical choke diameter values was compared to the actual values of the experimental chokes used in the model development (d_{0EXP}) and the percent error was computed. The values are presented for the 1¼″, 1½″, and 2″ ball valves in TABLES 4, 5, and 6 respectively below.

TABLE 4
1.25

| d_{oEXP(in)} | d_{oTH} (in) | % Error |
|---|---|---|
| 0.500 | 0.506 | 1.16 |
| 0.595 | 0.575 | 3.42 |
| 0.606 | 0.583 | 3.83 |
| 0.625 | 0.606 | 3.10 |
| 0.750 | 0.735 | 1.97 |
| 0.830 | 0.815 | 1.80 |
| 0.889 | 0.895 | 0.69 |
| 0.942 | 0.958 | 1.67 |
| 1.184 | 1.137 | 3.94 |

TABLE 5
1.5

| dₒ (in)_{Exp} | dₒ (in)_{Theo} | % Error |
|---|---|---|
| 0.750 | 0.795 | 6.03 |
| 0.782 | 0.803 | 2.72 |
| 0.817 | 0.821 | 0.52 |
| 0.873 | 0.850 | 2.62 |
| 0.928 | 0.916 | 1.31 |
| 0.931 | 0.919 | 1.24 |
| 0.952 | 0.948 | 0.40 |
| 1.023 | 0.996 | 2.56 |
| 1.060 | 1.049 | 1.06 |
| 1.071 | 1.069 | 0.20 |
| 1.074 | 1.073 | 0.06 |
| 1.496 | 1.507 | 0.72 |

TABLE 6
2.0

| dₒ (in)_{Exp} | dₒ (in)_{Theo} | % Error |
|---|---|---|
| 1.000 | 1.071 | 7.13 |
| 1.055 | 1.096 | 3.92 |
| 1.062 | 1.107 | 4.23 |
| 1.220 | 1.220 | 0.04 |
| 1.250 | 1.230 | 1.59 |
| 1.280 | 1.248 | 2.49 |
| 1.278 | 1.264 | 1.08 |
| 1.295 | 1.273 | 1.70 |
| 1.310 | 1.290 | 1.49 |
| 1.375 | 1.369 | 0.46 |
| 1.420 | 1.406 | 1.00 |
| 1.460 | 1.471 | 0.78 |
| 1.467 | 1.474 | 0.50 |
| 1.468 | 1.484 | 1.12 |
| 1.469 | 1.516 | 3.23 |
| 1.480 | 1.524 | 2.97 |
| 1.974 | 1.973 | 0.05 |

From TABLES 4, 5, and 6, the maximum error between the actual value of the experimental orifice diameter (d_{0EXP}) and the theoretical value of orifice diameter (d_{0TH}) determined from the model is 7.13%, with an average error of 1.97%.

### 2. Choke Design with Reynolds-based Model

It has been demonstrated that a common trend line can describe measured values of choke Reynolds numbers and corresponding pipe Reynolds numbers for three different pipe sizes, and further, that the above relationship can be incorporated into a model which accurately predicts an orifice throat diameter value corresponding to a desired flow coefficient. Accordingly, such a dimensionless model may be employed in the design of flow restriction devices to be installed in a piping system to obtain a desired flow coefficient through an existing flow restriction, which may be an existing valve. Also, by virtue of the dimensionless character of the model, the dimension of a flow restriction may be calculated for pipe and valve diameters outside the range of tested valve and pipe sizes.

In the second method of the present invention, a model as developed according to the first method determines the characteristic dimension of a choke corresponding to a desired value of flow coefficient C_{ν}. Given the above equation modeling the Reynolds number for the flow through a choke as a function of the Reynolds number for the flow through each pipe, the inner diameter of a choke corresponding to a desired valve flow coefficient can be determined. This procedure involves the steps of calculating the pipe Reynolds number, determining the orifice Reynolds number, and determining the choke inner diameter corresponding orifice Reynolds number. The steps are discussed in detail below.

In determining the pipe Reynolds number, the desired flow coefficient must first be converted into volumetric flow rate Q. By definition, C_{ν} is the number of gallons per minute of water that will flow through the test valve at a 1-psi differential pressure drop across the valve. Further, C_{ν} can be expressed in the following form:

$${C}_{v} = \frac{Q}{\sqrt{\frac{Δ {p}_{v}}{{G}_{g}}}}$$

With water as the system fluid, the specific gravity, G_{g} is 1.0. Also, referring to the definition of C_{ν}, Δp_{ν} can be set equal to 1 psi. Under these conditions, the denominator of the above equation simplifies to 1 and Q is equal to the desired C_{ν} value and is expressed in gallons per minute (gpm). If water is not the system fluid, the specific gravity of the fluid relative to water (G_{g}) is calculated and the resulting value is substituted into the above C_{ν} equation. This expression may alternately be referred to as a discharge coefficient, in that C_{ν} is typically associated with water.

Having determined the volumetric flow rate corresponding to the desired flow coefficient and given the actual inner diameter of the pipe dᵢ (in feet), the pipe Reynolds number is calculated in accordance with the following relationship:

$${Re}_{di} = \frac{4 Q}{π {d}_{i} v}$$

It is noted that the above equation calls for Q to be in ft³/s. Q is converted into the proper units be the following conversion factors: 1 gallon=0.13368 ft³ and 1 minute=60 s. Additionally, the kinematic viscosity term ν is defined by the following relationship:

$$v = \frac{μ {g}_{c}}{ρ}$$

where: ρ=Density of fluid (lbm/ft³);

μ=Absolute viscosity of fluid

$$( \frac{lbf \cdot s}{{ft}^{2}} ) ;$$

and

g_{c}=Conversion factor (32.2 lbm·ft/lbf·s²).

For water, ν is equal to 9.37×10⁻⁶ (ft²/s).

After determining the value for the pipe Reynolds number, the value is substituted into the equation modeling the orifice Reynolds number as follows:

Re_{d0}=X1*Re_{di}³+X2*Re_{di}²+X3*Re_{di}+X4

where: X1, X2, X3, and X4 are coefficients for curve fit.

The resulting orifice Reynolds number is then substituted into the following equation:

$${d}_{o} = \frac{4 Q}{π {Re}_{do} v}$$

This calculated value of d₀ gives the throat diameter of the choke to yield the desired C_{ν} value.

As a prophetic example, the Reynolds model developed above will be used to determine a choke dimension for a valve size that was not included in the model. The orifice throat diameter required to yield a desired C_{ν} of 12 in a ¾″ schedule 80 PVC piping system wherein water is the fluid and employing the model as described above is determined as follows:

First, the given value of C_{ν} is converted to Q according to the following relationship:

$${C}_{v} = \frac{Q}{\sqrt{\frac{Δ {p}_{v}}{{G}_{g}}}}$$

Next, the Reynolds number for the ¾″ pipe is determined. The actual inner diameter of a ¾″ schedule 80 PVC pipe is 0.74196″, or 0.06183 ft.

$$\begin{matrix}{Re}_{di} = \frac{4 ( 12 )}{π ( 0.06183 ft ) ( 9.37 \times {10}^{- 6} {ft}^{2} \text{/} s )} \frac{0.13368 {ft}^{3}}{60 s} \\ = 58 \text{,} 758\end{matrix}$$

After determining the Reynolds number for the 2″ pipe, the model is used to determine the value of the Reynolds number of the orifice:

Re_{d0}=3×10⁻¹²Re_{di} ³3×10⁻⁶Re_{di}²+1.5101Re_{di}+21643=100,625

Finally, the inner diameter is determined:

$$\begin{matrix}{d}_{o} = \frac{4 \cdot 12}{π ( 100 \text{,} 625 ) ( 9.37 \times {10}^{- 6} {ft}^{2} \text{/} s )} \frac{0.13368 {ft}^{3}}{60 s} \\ = 0.0361 ft \\ = 0.433 inches\end{matrix}$$

Thus, a choke with a throat diameter of 0.433″ will yield the desired flow coefficient of 12 for the ¾″ valve.

Therefore, it can be seen that the objects of the invention have been satisfied by the technique and process presented above. By evaluating the flow performance of a plurality of experimental choke sizes, a dimensionless Reynolds-based model can be determined to describe the characteristic dimension of a choke for a specified flow coefficient value. Accordingly, such a model can be used to design a choke for a particular application, including the modification of existing flow control devices to desired flow parameter.

It is believed that the operation and structure of the present invention and practice thereof will be apparent from the foregoing description. While the method and apparatus shown and described has been characterized as being preferred, obvious changes and modifications may be made without departing from the spirit and scope of the invention as defined in the following claims.

I claim:

1. A method for modeling flow performance, comprising:
(1) Determining the flow coefficient for plurality of flow restrictions operatively installed to a length of pipe, wherein the characteristic dimension of each flow restriction varies relative to the other flow restrictions;
(2) Using the values measured in step (1) to determine a value for the Reynolds number of the pipe at each measured data point;
(3) Using the values measured in step (1) to determine a value for the Reynolds number of the flow restriction at each measured data point;
(4) Using the values for the Reynolds number for the pipe determined in step (2) and the values for the Reynolds number for the flow restrictions determined step (3) to empirically determine a mathematical relationship describing the Reynolds number of the flow restrictions as a function of the Reynolds number of the pipe; and
(5) Using the mathematical relationship determined in step (4) to determine a mathematical relationship describing the characteristic dimension of a flow restriction as a function of the actual inner diameter of a specified pipe and a desired flow coefficient.

2. A method for modeling flow performance as set forth in claim 1 in which the step of determining the flow coefficient for a plurality of flow restrictions as set forth in step (1) is performed in combination with a flow control device, in which the flow coefficient of the flow control device is determined without a flow restriction installed and with a plurality of flow restrictions operatively installed in combination with the flow control device.

3. A method for modeling flow performance as set forth in claim 1 in which the step of determining the flow coefficient for a plurality of flow restrictions as set forth in step (1) further comprises the following steps:
(1) Measuring the flow rate of an open pipe section of a specified inner diameter at a plurality of different pressure drops;
(2) Measuring the flow rate of an existing flow control device at a plurality of different pressure drops;
(3) Modifying the existing flow control device by placing a operatively installing a choke proximately upstream of the existing flow control device.
(4) Measuring the flow rate of the modified existing flow control device of step (3) at a plurality of different pressure drops;
(5) Repeating steps (3) and (4) for a plurality of different chokes, each such choke having an inner diameter varying in relation to the inner diameter of the choke used for the previous iterations, and measuring the flow rate of each such modified existing flow control device at a plurality of different pressure drops;
(6) Using the values measured and employed in steps (1) and (2) to empirically determine a mathematical relationship describing the pressure drop across the flow control device as a function of the volumetric flow rate;
(7) Using the values measured and employed in steps (3)-(5) to determine mathematical relationships describing the pressure drop across each modified flow control device as a function of volumetric flow rate;
(8) Using the mathematical relationships determined in steps (6) and (7) to determine values for the flow coefficient of flow control device alone and as modified by each choke.

4. A method for modeling flow performance as set forth in claim 1 in which the characteristic dimensions of the plurality of flow restrictions of step (1) are determined in accordance with the following relationship:
$${d}^{′} = {d}_{0} - ( \frac{{C}_{v0} - {C}_{vg}}{m} )$$
where:
d′=resultant choke diameter (in);
d₀=initial value of choke diameter (in);
C_{ν0}=initial value of C_{ν};
C_{νg}=given value of C_{ν}; and
m=the slope of a line between two data points.

5. A method for modeling flow performance as set forth in claim 1 in which the flow control device is a valve operatively installed between two lengths of pipe, and said valve is fully open.

6. A method for modeling flow performance as set forth in claim 1 in which the step of determining values for the Reynolds number of the pipe at each measured data point as set forth in step (2) is determined in accordance with the following relationship:
$${Re}_{di} = \frac{4 Q}{π {d}_{i} v}$$
where:
Q=Volumetric flow rate (ft³/s);
dᵢ=Actual inside diameter of pipe (ft); and
ν=Kinematic viscosity of fluid (ft²/s).

7. A method for modeling flow performance as set forth in claim 1 in which the step of determining values for the Reynolds number of flow control device at each measured data point as set forth in step (3) is determined in accordance with the following relationship:
$${Re}_{do} = \frac{4 Q}{π {d}_{0} v}$$
where:
Q=Volumetric flow rate (ft³/s);
d₀=Actual inside diameter of the choke (ft); and
ν=Kinematic viscosity of fluid (ft²/s).

8. A method for modeling flow performance as set forth in claim 1 in which the step of Using the values for the Reynolds number for the pipe determined in step (2) and the values for the Reynolds number for the flow control device determined step (3) to empirically determine a mathematical relationship describing the Reynolds number of the flow control device as a function of the Reynolds number of the pipe as set forth in step (4) is determined in accordance with the following relationship:
Re_{d0}=M1*Re_{di}³+M2*Re_{di}²+M3*Re_{di}+M4
where:
M1, M2, M3, M4=coefficients for curve fit; and
Re_{di}=Reynolds number for the pipe.

9. A method for modeling flow performance as set forth in claim 1 in which steps (1)-(4) are repeated for a plurality flow control devices and values for the Reynolds number of each pipe are determined as set forth in step (2) and values for the Reynolds numbers of flow control device are determined as set forth in step (3);

10. A method for modeling flow performance as set forth in claim 1 in which the step of using the mathematical relationship determined in step (4) to determine a mathematical relationship describing the characteristic dimension of flow restriction as a function of the actual inner diameter of a specified pipe and a desired flow coefficient as set forth in step (5) is determined in accordance with the following relationship:
$${d}_{o} = \frac{4 Q}{π {Re}_{do} v}$$
where:
Q=Volumetric flow rate (ft³/s);
Re_{d0}=Reynolds number of flow control device; and
ν=Kinematic viscosity of fluid (ft²/s).

11. A method of designing a flow control device, comprising:
(1) Generating a Reynolds-based model describing the flow performance of a set of flow control devices and a plurality of chokes;
(2) Selecting a value for the inner diameter of a pipe connected to a flow control device;
(3) Selecting a value for the desired flow coefficient through the flow control device;
(4) Using the values for the inner diameter of a pipe selected in step (2) and the desired flow coefficient selected in step (3) to calculate a value for the Reynolds number for the pipe;
(5) Using the Reynolds-based model developed on step (1) and the Reynolds number for the pipe calculated in step (4) to determine the characteristic dimension of a choke corresponding to the desired flow coefficient value; and
(6) Using the characteristic dimension determined in step (4) to produce a choke.

12. A method of designing a flow control device as set forth in claim 11 in which the step of generating a Reynolds based model describing the flow performance of a set of flow control devices and a plurality of chokes in step (1) is repeated for a plurality of different pipe sizes.

13. A method of designing a flow control device as set forth in claim 11 in which the step of selecting a value for the desired flow coefficient through the flow control device as set forth in step (2) further comprises converting the selected flow coefficient value into a corresponding value for the volumetric flow rate according to the following relationship:
$${C}_{v} = \frac{Q}{\sqrt{\frac{Δ {p}_{v}}{{G}_{g}}}}$$
where:
Q=Volumetric flow rate (gpm);
Δp_{ν}=differential pressure across the valve (psi); and
G_{g}=specific gravity of fluid relative to water (unitless),
and the resulting value for Q is converted into the units of ft³/s.

14. A method of designing a flow control device as set forth in claim 11 in which the step of calculating a value for the Reynolds number for the pipe as set forth in step (4) is determined in accordance with the following relationship:
$${Re}_{di} = \frac{4 Q}{π {d}_{i} v}$$
where:
Q=Volumetric flow rate (ft³/s);
dᵢ=Actual inside diameter of pipe (ft); and
ν=Kinematic viscosity of fluid (ft²/s).

15. A method for designing a flow control device as set forth in claim 11 in which the Reynolds-based model is determined in accordance with the following relationship;
Re_{d0}=M1*Re_{di}³+M2*Re_{di}²+M3*Re_{di}+M4
where:
M1, M2, M3, M4=coefficients for curve fit; and
Re_{di}=Reynolds number for the pipe.

16. A method of designing a flow control device as set forth in claim 11 in which the step of using the Reynolds based model developed on step (1) and the values selected in steps (2) and (3) to determine the characteristic dimension of a choke corresponding to the desired flow coefficient value as set forth in step (4) is determined in accordance with the following relationship:
$${d}_{o} = \frac{4 Q}{π {Re}_{do} v}$$
where:
Q=Volumetric flow rate (ft³/s);
Re_{d0}=Reynolds number of flow control device; and
ν=Kinematic viscosity of fluid (ft²/s).

17. A method of designing a flow control device as set forth in claim 11 in which the choke produced in step (5) is operatively installed proximately upstream of a flow control device.
